(19) United States
(12) Patent Application Publication
(10) Pub. No.: US 2023/0219772 A1
(43) Pub. Date: Jul. 13, 2023

(54) STACKING APPARATUS

(71) Applicant: Weber Maschinenbau GmbH Breidenbach, Breidenbach (DE)

(72) Inventors: Marvin SCHÄFER, Biedenkopf (DE); Thorsten SCHNEIDER, Weimar/Lahn (DE); Julian NOLTE, Leun-Biskirchen (DE)

(21) Appl. No.: 18/085,091

(22) Filed: Dec. 20, 2022

(30) Foreign Application Priority Data
Dec. 21, 2021 (DE) 102021134019.5
Mar. 22, 2022 (DE) 102022106685.1

(51) Int. Cl. B65G 57/04; B65G 47/91

(52) U.S. Cl. CPC B65G 57/04; B65G 47/915; B65G 47/917; B65G 2201/0202

(57) ABSTRACT

A stacking apparatus for preparing food portions comprises at least one product support movable between a feed position and a depositing position, wherein, in the feed position of the product support, a part portion of the food portion to be prepared can be conveyed along a conveying direction onto a support surface of the product support, and wherein the stacking apparatus is configured to place the part portion conveyed onto the product support beneath the product support by moving the product support into the depositing position, in particular to stack the part portion conveyed onto the product support on a previously placed part portion. In the product support, at least one pneumatic channel is furthermore formed that can be connected to a device for generating a pressure difference and that has at least one orifice into the support surface.

The invention relates to a stacking apparatus for preparing food portions that comprises at least one product support movable between a feed position and a depositing position, wherein, in the feed position of the product support, a part portion of the food portion to be prepared may be conveyed along a conveying direction onto a support surface of the product support. The stacking apparatus is configured to place the part portion conveyed onto the product support beneath the product support by moving the product support into the depositing position and in particular to stack the part portion conveyed onto the product support on a previously placed part portion.

When processing food products, in particular meat or cheese products, provision may be made to prepare individual food portions from the food products and to package the food portions to be able to offer the food products for sale portioned in such a manner. For example, food portions may be prepared by cutting off slices from a food product by means of a slicing apparatus, in particular a so-called high-performance slicer, wherein a respective portion may comprise one or more slices. The portions prepared may thereupon, for example, be transferred to a packaging machine so that the portions may be individually packaged and sold.

Whereas, in particular when selling the food products or the food portions to end consumers, provision may be made to individually package and offer the portions prepared by the slicing apparatus, provision may also be made to divide a food product into a plurality of part portions, but to join together the part portions to form a common food portion and to package them together to be able to supply customers that have a large demand for food products, for example, from the catering industry. For this purpose, a plurality of part portions may in particular be stacked on top of one another and then packaged, wherein bottom layers may, for example, be inserted under the individual part portions by means of a so-called underleaver so that the part portions stacked on top of one another may be separated from one another in the package by a piece of paper or a film and may thereby be removable portion-wise from the package.

To enable an assembly of a plurality of part portions to form a common food portion in particular to be packaged together, stacking apparatuses of the initially mentioned kind may in particular be provided that may, for example, be used in a processing line between a slicing apparatus and a packaging machine. In such a processing line, the part portions that are, for instance, prepared by a high-performance slicer may be successively conveyed onto the product support of the stacking apparatus and may be placed below the product support, for example on a transport belt, by moving the product support into the depositing position so that a stack of a plurality of part portions may be formed and may be transferred to a packaging machine after completion of a food portion. It is further conceivable that, in further process steps, the stack formed from a plurality of part portions is joined together with further part portions and/or stacks of part portions in a food processing line to form a complete portion together with them.

The product supports of such stacking apparatuses may, for example, be provided as flaps which are produced from plastic and onto which the part portions are so-to-say pushed by means of a conveyor belt. However, during such a pushing on, deflections of the part portions may occur due to the friction between the part portion and the support surface of the product support so that the part portions may possibly not be exactly positioned on the stacking apparatus. Such deflections may also occur during the placement of a part portion. However, such deflections may have the result that the part portions are not placed and stacked on top of one another precisely or in the intended manner so that complex manual checks and corrections of food portions formed by means of such a stacking apparatus are often required.

It is therefore an object of the invention to provide a stacking apparatus that enables an exact positioning of the part portions on the support surface of the product support and a precise placement of the part portions.

This object is satisfied by a stacking apparatus having the features of claim 1 and in particular in that, in the product support, at least one pneumatic channel is formed that may be connected to a device for generating a pressure difference and that has at least one orifice into the support surface.

Since such a pneumatic channel is formed in the product support, such a pressure difference may also be generated at the orifice into the support surface by connecting the pneumatic channel to a device for generating a pressure difference. For example, an air cushion may thereby be formed at the support surface in that compressed air is conducted through the pneumatic channel and accordingly flows out of the orifice. Such an air cushion may in particular be used to assist the conveying of a part portion onto the support surface and to prevent an uncontrolled deceleration and a thereby induced deflection of the part portion. Furthermore, by connecting the pneumatic channel to a device for generating a pressure difference, an air flow directed into the orifice of the pneumatic channel may, for example, also be generated at the support surface in that a vacuum is generated and/or air is sucked in through the pneumatic channel by means of the device for generating a pressure difference. This, for example, makes it possible to intentionally decelerate the part portion when reaching a desired position on the product support and/or to suck the part portion onto the product support to prevent a movement of the part portion beyond this position.

To be able to achieve an assistance of the conveying onto the product support, an air flow directed out of the orifice and having a component along the conveying direction may in particular be producible by connecting the pneumatic channel to the device for generating a pressure difference. For a deceleration and/or an intentional positioning of a part portion, in contrast, an air flow into the orifice may, for example, be generated that may have a component against the conveying direction or may be directed perpendicular into the product support surface. Alternatively thereto, a braking may also be generated by an air flow directed out of the orifice in that this air flow may, for example, have a component against the conveying direction. Such guidances of the air flow may in particular be achieved by a corresponding orientation of the at least one orifice that may, for example, be oriented inclined in or against the conveying direction or may be oriented perpendicular to the conveying direction. Furthermore, the pneumatic channel may have a plurality of orifices into the support surface in order, for example, to be able to assist a conveying of a part portion onto the product support across the total product support.

To be able to form the air cushion mentioned at the support surface for conveying and/or decelerating a part portion, the device for generating a pressure difference may, for example, be configured as a compressed air device and may in particular comprise a fan. Alternatively or additionally, the device for generating a pressure difference may, however, also be configured as a vacuum device to be able to generate an air flow into the support surface and, for example, to be able to decelerate the part portion. Furthermore, provision may be made that the device for generating a pressure difference may be switched over to be able to generate both a compressed air flow along the support surface and an air flow directed into the support surface and, for example, to first be able to assist the conveying of a part portion onto the product support and to then be able to intentionally decelerate the conveying by switching over the device for generating a pressure difference. Thus, the device for generating a pressure difference may, for example, comprise a compressed air device, in particular a fan, and a vacuum device. Alternatively thereto, respective separate devices for generating a compressed air flow and a vacuum may also be connectable to the at least one pneumatic channel, wherein an assistance of the conveying of the part portion onto the product support or a deceleration of the part portion may be achieved by a respective control of these devices. For this purpose, a plurality of pneumatic channels may in particular also be formed in the product support, wherein, for example, one pneumatic channel may be provided for connection to a compressed air device and one pneumatic channel may be provided for connection to a vacuum device.

Furthermore, the device for generating a compressed air flow may generally be formed separately from the stacking apparatus and may be selectively connectable to the stacking apparatus, wherein provision may alternatively thereto be made that the stacking apparatus comprises the device for generating a pressure difference and/or a compressed air device and a vacuum device.

The support surface may be in particular be aligned in parallel with the conveying direction in the feed position of the product support. Such an alignment of the support surface may make it possible to push the part portions onto the product support in a straight line along the conveying direction and to then intentionally place them by moving the product support into the depositing position. For this purpose, the product support may, for example, be pivoted so that the part portion may be placed by sliding down from the support surface. This placement may also take place more precisely by configuring the product support with a pneumatic channel in that, for example by generating a compressed air flow directed out of the orifice, the friction between the part portion and the support surface may be reduced and an unwanted deflection movement of the part portion during the placement may thereby be prevented. Furthermore, an intentional generation of a vacuum at the orifice may, for example, make it possible to so-to-say firmly hold the part portion in the region of the orifice during the placement and thereby to control and/or to slow down the slipping off of the part portion in order to achieve a controlled placement.

The orifice of the pneumatic channel into the support surface may in particular be formed by a straight-line section of the pneumatic channel that leads through the product support to the support surface. In this regard, the orifice may, for example, branch off from a section of the pneumatic channel extending in the interior of the product support to establish a connection between the support surface and the pneumatic channel.

Further embodiments can be seen from the dependent claims, the description, and the drawings.

In some embodiments, the pneumatic channel may have a connection for the device for generating a pressure difference to the product support and may, starting from the connection, extend in the interior of the product support, between the support surface and a lower side of the product support opposite the support surface, to the at least one orifice.

The at least one pneumatic channel may in particular extend completely in the interior of the product support and may only have orifices out of the product support in the form of the at least one orifice and the connection. In particular, the pneumatic channel may thus not be formed by lines extending at an outer side of the product support, but may rather not be recognizable from the outside at the product support—apart from the at least one orifice and the connection. The product support may further in particular be cuboid and the support surface may be formed by one of the two largest rectangular surfaces or a broad side of the cuboid, while the connection may be formed at one of the narrow sides of the cuboid. Furthermore, a pneumatic channel extending in the interior of the product support may not be formed by a material different from the further components of the product support, but may rather be formed directly by an open structure that extends in the interior of the product support in the manner of a bore, but that is possibly shaped and/or branched. To be able to form such a pneumatic channel in the interior of the product support, the product support may, for example, be manufactured by a 3D printing process. In contrast, the device for generating a pressure difference may, for example, be connectable to the connection of the pneumatic channel via a line.

In some embodiments, the orifice of the pneumatic channel may be oriented inclined to the support surface. In such embodiments, an air flow passing through the orifice may thus exit or enter obliquely to the support surface in order, for example, to be able to convey the part portion onto the support surface through an air flow directed out of the orifice and flowing with a component along the conveying direction. Alternatively thereto, a braking effect may, for example, likewise be achieved by an air flow directed out of the orifice in that the orifice is oriented inclined to the support surface such that the air flow exiting from the orifice has a component against the conveying direction. On a generation of a vacuum by means of the device for generating a pressure difference, it may, for example, also be achieved by a correspondingly inclined orientation of the orifice that the part portion conveyed onto the support surface is both sucked onto the support surface and decelerated against a movement along the conveying direction.

In some embodiments, the orifice of the pneumatic channel may be oriented at an acute angle to the support surface. The orifice may in particular be oriented at an angle between 5 degrees and 30 degrees, preferably at an angle between 10 degrees and 20 degrees, and/or at an angle of 15 degrees to the support surface. In particular due to such an orientation at an acute angle, a sufficient component of an air flow directed out of the orifice along the conveying direction may, for example, be achieved to be able to assist the conveying of a part portion onto the product support.

In some embodiments, a straight-line extension of the orifice of the pneumatic channel out of the support surface may adopt an acute angle with respect to the conveying direction in the feed position of the product support. The straight-line extension of the orifice out of the support surface may in particular have an angle between 5 degrees and 30 degrees, preferably an angle between 10 degrees and 20 degrees, and/or an angle of 15 degrees with respect to the conveying direction. In such embodiments, a compressed air flow at the support surface generated by the device for generating a pressure difference may thus in particular have a component along the conveying direction so that the conveying of a part portion onto the product support may be assisted by applying compressed air to the pneumatic channel. An air flow entering an orifice oriented in such a manner through a sucking in of air may, however, have a component against the conveying direction to be able to achieve a braking effect, for example. Alternatively thereto, in other embodiments, provision may, however, also be made that a straight-line extension of the orifice of the pneumatic channel out of the support surface adopts an obtuse angle, in particular an angle in a range of 180 degrees minus one of the aforementioned acute angles and/or an angle of 165 degrees, with respect to the conveying direction in the feed position of the product support and is thus oriented against the conveying direction. This may make it possible to generate an air flow against the conveying direction at the support surface by applying compressed air to the pneumatic channel to be able to intentionally decelerate a part portion conveyed onto the product support.

In some embodiments, the orifice of the pneumatic channel may be oriented in the direction of a central section of the support surface. The orifice of the pneumatic channel may in particular be oriented in the direction of a section of the support surface that is a central section with respect to a transverse direction oriented perpendicular to the conveying direction. Due to such an orientation of the orifice, a compressed air flow directed out of the orifice may, for example, be generated in the direction of the central section of the support surface to be able to achieve a centering of the part portion on the product support and to be able to laterally stabilize the part portion during the conveying onto the product support.

Furthermore, in some embodiments, the orifice may be oriented perpendicular to the support surface. Such an orifice oriented perpendicular to the support surface may in particular be provided when the device for generating a pressure difference is configured to suck in air through the orifice or the pneumatic channel may be connected to a vacuum device. With such an orientation, an air flow directed perpendicular into the support surface may be generated to suck in a part portion conveyed onto the product support and thereby, for example, to be able to decelerate and intentionally position said part portion on the product support. Equally, due to such an air flow directed into the product support, for example during a placement of a part portion, a possible slipping off of the part portion may be controlled and slowed down in order to place the part portion and to stack it on a previously placed part portion or the friction between the part portion and the support surface may be intentionally reduced before and/or during the placement by a compressed air flow flowing out of such an orifice.

In some embodiments, the orifice may be formed as a shallow depression, as a shallow funnel, or as a trough and/or may merge into a shallow groove formed at the support surface. Due to such a design of the orifice, an air flow generated at the support surface by applying compressed air to the pneumatic channel may in particular be assisted and/or guided to enable an intentional conveying of a part portion onto the product support and/or an intentional placement of the part portion.

In some embodiments, the pneumatic channel may have a plurality of orifices into the support surface. As already explained, an assistance of the conveying of a part portion onto the product support at a plurality of points of the product support and/or an intentional deceleration of a part portion at a plurality of points of the product support may thereby in particular be achieved.

In some embodiments, the pneumatic channel may have a connection section for connecting the pneumatic channel to the device for generating a pressure difference, a supply section, and a plurality of work sections branching off from the supply section. Furthermore, in such embodiments, the supply section may form the connection section or may merge into the connection section and each of the work sections may at least lead to a respective orifice into the support surface. In some embodiments, provision may also be made that the connection section acts as a work section in that the connection section of the pneumatic channel may communicate with at least one orifice into the support surface.

The connection section of the pneumatic channel may in particular form the already mentioned connection for the device for generating a pressure difference, wherein the connection may in particular represent an opening of the connection section at an outer side of the product support. The supply section may, for example, extend along the conveying direction, wherein orifices arranged offset from one another along the conveying device may be connected to the device for generating a pressure difference by the plurality of branching-off work sections. Each of the plurality of work sections may in particular lead to a plurality of orifices associated with the respective work section in order, for example, to be able to connect a plurality of orifices arranged offset from one another along a direction of extent of the work section, in particular a transverse direction oriented perpendicular to the conveying direction, to the device for generating a pressure difference.

In some embodiments, the supply section may be aligned in parallel with the conveying direction. Furthermore, the work sections may be aligned in parallel with one another and/or may be oriented perpendicular to the conveying direction. The work sections may in particular branch off perpendicular to the conveying direction from a supply section extending in parallel with the conveying direction in order thereby to be able to connect orifices arranged offset from one another along the conveying direction to the device for generating a pressure difference. The supply section extending in parallel with the conveying direction may in particular extend in a marginal region of the product support so that the work sections may, starting from the marginal region, extend into the center and/or to the opposite marginal region of the product support. Alternatively thereto, the supply section may, however, also, for example, extend in a central region of the product support, wherein the work sections may, for example, branch off from the work section at both sides perpendicular to the conveying direction to be able to connect orifices arranged in marginal regions of the product support to the device for generating a pressure difference.

In some embodiments, the connection section may branch off from the supply section. In particular, the connection section may also be oriented perpendicular to the conveying direction and/or may lead to at least one orifice into the support surface.

For example, an orientation of the connection section perpendicular to the conveying direction may make it possible to form the already mentioned connection for the device for generating a pressure difference laterally at the product support with respect to the conveying direction and accordingly to laterally connect the device for generating a pressure difference. To connect the pneumatic channel, a corresponding line may thereby in particular extend in a lateral fastening for the product support so that the lines do not have to be arranged in a region in which the part portions are moved during the conveying and/or placement.

Furthermore, in some embodiments, a plurality of pneumatic channels may be formed in the product support and may in particular satisfy the same or different functions. In this respect, each of the pneumatic channels may in particular have a respective connection section so that the individual pneumatic channels may be connectable to respective devices for generating a pressure difference and/or may be selectively connectable to the device for generating a pressure difference. A control of different pneumatic channels may, for example, take place by a pneumatic circuit having valves or valve lenses, wherein such a circuit may in particular be arranged in a shaft to which the product support is fastened. Such an arrangement in the shaft may in particular enable a space-saving installation of the circuit.

Provision may, for example, be made that the product support has a pneumatic channel for generating a compressed air flow and a pneumatic channel for generating a vacuum and/or for sucking in air at the product support surface. However, provision may also be made that the product support has a plurality of pneumatic channels for generating a compressed air flow and/or a plurality of pneumatic channels for generating a vacuum and/or for sucking in air. This may, for example, make it possible to control a generated compressed air flow by connecting a respective pneumatic channel to the device for generating a pressure difference, for instance, by means of a valve circuit. For example, provision may be made to set the compressed air flow in dependence on previously recorded parameters of a processing line and/or of a part portion, which may take place through a corresponding selection of the pneumatic channel used. In this respect, a line speed, a part portion weight, a position of the part portion, or a possible rotation of the part portion may in particular be considered.

In some embodiments, the orifices may be arranged offset from one another along the conveying direction and/or transversely to the conveying direction. As already explained, the desired conveying and/or braking effect may thereby in particular be achieved over the total support surface.

The orifices may further be arranged at a constant spacing from one another along the conveying direction and/or transversely to the conveying direction or the spacing of the orifices from one another may vary along the conveying direction and/or transversely to the conveying direction. For example, provision may be made that a greater number of orifices are formed at a receiving side of the product support, and thus at the side of the product support at which the part portions move onto the product support, than in a central region of the product support. In particular the conveying of the part portions in a region in which the stacking apparatus, for instance, takes over the part portions from a conveyor belt arranged upstream may thereby be assisted. Equally, orifices may be increasingly arranged at a side of the product support opposite the receiving side to be able to reliably decelerate the part positions. Furthermore, more orifices may, for example, be provided at marginal sections of the support surface than at the center of the support surface to be able to achieve a centering of the part portions on the product support by a correspondingly directed airflow. In general, the density of the orifices at the support surface may thus vary, wherein a constant density of orifices may, however, also be provided.

In some embodiments, the orifices may be arranged in a plurality of rows, in particular in two, three, four, five, or six rows, that are oriented transversely to the conveying direction. These rows may in particular be associated with a respective one of the aforementioned work sections and the orifices of a respective row may be connected to the associated work section. Furthermore, the rows may extend perpendicular to the conveying direction and/or in parallel with one another. Each of the rows may furthermore be associated with a plurality of orifices, in particular two, three, four, five, or six orifices.

In some embodiments, the orifices may have an identical or a different cross-sectional surface in a plane in parallel with the support surface. Alternatively or additionally, in some embodiments, the orifices may have an identical or a different cross-sectional shape in a plane in parallel with the support surface.

For example, the orifices may have a circular, elliptical, or rectangular cross-sectional shape, wherein all of the plurality of orifices may have the same cross-sectional shape or different orifices may have different cross-sectional shapes. Furthermore, different orifices may have different cross-sectional surfaces, due to a different cross-sectional shape or also in the case of an identical cross-sectional shape, or the plurality of orifices may, likewise in the case of an identical or a different cross-sectional surface, always have the same cross-sectional surface. The air flow exiting from and/or entering the respective orifice may also be influenced by an adaptation of the cross-sectional surface and/or of the cross-sectional shape in order to enable a conveying or deceleration of part portions that is as precise as possible and/or sectionally adapted.

In some embodiments, the orifices may be arranged closer to one another in a marginal section of the support surface than in a central section of the support surface. Such a higher density of orifices in a marginal section of the support surface may in particular be provided on an orientation of the orifices in the direction of the central section of the support surface in order, for example, to be able to center a part portion during the conveying onto the product support.

In some embodiments, the product support may be connected at an outer side to a rotatable shaft, wherein the product support may be pivotable from the feed position into the depositing position by rotating the shaft. The product support may in particular be pivotable from the feed position into the depositing position by rotating the shaft about 90 degrees.

The connection of the product support to the shaft may e.g. take place by one or more manually actuable quick release fasteners so that the product support may be assembled without tools and consequently quickly and easily and may e.g. be removed for cleaning or replacement purposes.

In such embodiments, the product support may thus so-to-say be configured as a flap on which a part portion may first be conveyed to place the part portion by pivoting the flap. To enable a successive placement of consecutive part portions, the shaft may, for example, be rotatable in opposite directions so that, after the placement of a part portion, the product support may be transferred from the depositing position into the feed position again by a rotation of the shaft opposite to the placement, in particular about 90 degrees. However, provision may also be made that the shaft is rotatable along a single direction of rotation to move the product support between the depositing position and the feed position. In such embodiments, provision may, for example, be made that a plurality of product supports are arranged offset by a certain angle at the shaft so that, by rotating the shaft about the certain angle, a part portion may be placed and a following product support may simultaneously be brought into the feed position to be able to convey a subsequent part portion onto the following product support. Alternatively thereto, it is, however, also possible for the shaft to be rotated about 360 degrees in the course of a placement of a part portion so that the product support may automatically be guided via the depositing position back into the feed position in order to pick up the subsequent part portion.

In some embodiments, at least one pneumatic line may be formed in the rotatable shaft, via which pneumatic line the at least one pneumatic channel may be connected to the device for generating a pressure difference. For this purpose, the at least one pneumatic channel may in particular have a connection section oriented transversely to the conveying direction for connection to the pneumatic line, said connection section being able to form a connection for the pneumatic line at one side of the product support. The pneumatic line may thereby be guided in the interior of the shaft so that the connection of the device for generating a pressure difference to the product support may take place without lines having to extend outside the other components of the stacking apparatus.

In some embodiments, the shaft may be connected via a friction clutch to a motor for driving the shaft. The shaft to which the product support is fastened may in particular be connected by a friction clutch to a motor shaft of the motor so that the torque that may be transmitted from the motor to the shaft may be limited and fixed. Accordingly, the friction clutch may be designed such that the product support fastened to the shaft may only be moved with a certain maximum force.

Such a connection between the shaft and the motor in particular makes it possible to dispense with complex safety precautions and nevertheless to meet predefined safety requirements. It may in particular be necessary with stacking apparatuses of the kind described in the present application to provide an intervention protection in order to prevent a reaching into the region of the product supports by a user during the operation and to prevent injuries that are thereby caused. Since the force that may be transmitted by the product supports may be limited by the friction clutch, which may also be designated as a slip clutch, the relevant safety standards may in particular already be satisfied by a smaller housing as intervention protection or even without intervention protection. Improved access to the product supports, for instance for maintenance or cleaning purposes, may thereby be made possible without having to accept relevant safety losses.

In some embodiments, in the product support, at least a first pneumatic channel may be formed that may be connected to a compressed air device for generating compressed air and that has at least one compressed air orifice into the support surface and, in the product support, at least a second pneumatic channel may be formed that may be connected to a vacuum device for generating a vacuum and that has at least one vacuum orifice into the support surface.

Accordingly, two pneumatic lines may in particular also be formed in a shaft to which the product support is connected for moving the product support between the feed position and the depositing position to be able to connect the two pneumatic channels to the corresponding compressed air device or vacuum device.

In such a configuration of the product support, both a compressed air flow along the support surface and an air flow directed into the support surface may be generated to selectively be able to assist the conveying of a part portion onto the product support or be able to decelerate the part portion and intentionally position it on the product support. The two pneumatic channels may in particular have the previously mentioned features and may, for example, comprise a respective connection section, a respective supply section, and a plurality of respective work sections that branch off from the supply section. Equally, the compressed air orifices and the vacuum orifices may have the features mentioned above in connection with the at least one orifice and may, for example, be oriented inclined or perpendicular to the conveying direction.

In some embodiments, the at least one compressed air orifice may be oriented inclined to the support surface and the at least one vacuum orifice may be oriented perpendicular to the support surface. Furthermore, provision may be made that the compressed air orifice and the vacuum orifice have a different cross-section, in particular a different cross-sectional shape and/or a different cross-sectional surface, or an identical cross-section, in particular an identical cross-sectional shape and/or an identical cross-sectional surface. Furthermore, the at least one compressed air orifice may in particular be oriented inclined to the support surface such that a compressed air flow exiting from the compressed air orifice has a component in the direction of the conveying direction to be able to assist the conveying of a part portion onto the product support. The at least one compressed air orifice may furthermore be oriented in the direction of a central section of the product support to be able to center a part portion on the product support.

Furthermore, in some embodiments, the product support may comprise a plurality of first pneumatic channels selectively connectable to the compressed air device and having at least one respective compressed air orifice and/or a plurality of second pneumatic channels selectively connectable to the vacuum device and having at least one respective vacuum orifice, wherein an arrangement and/or a cross-section of the compressed air orifices of different first pneumatic channels and/or of the vacuum orifices of different second pneumatic channels may differ from one another. In particular, the respective air flows that may be generated by connecting different first pneumatic channels or second pneumatic channels may thus also differ from one another so that an adaptation of the producible air flow to a certain product or properties of a part portion to be processed may be achieved, for example, by changing the respective first pneumatic channel or second pneumatic channel connected to a device for generating a pressure difference. In particular, the air flows may, for example, be adaptable in dependence on a weight and/or a size of the part portions to be processed in such a configuration of the product support.

In some embodiments, the stacking apparatus may comprise a control device for controlling the device for generating a pressure difference.

In some embodiments, the control device may be configured to control the device for generating a pressure difference during the conveying of the part portions onto the product support to first apply compressed air to the at least one pneumatic channel and to then suck in air through the at least one pneumatic channel. Due to such a control of the device for generating a pressure difference, an air cushion may thus first be produced at the support surface in order, for example, to convey a part portion onto the product support, whereupon the part portion may, just before or on reaching the desired position, be braked against a movement along the conveying direction, and may thereby be positioned on the product support, by sucking in air through the at least one pneumatic channel.

To enable such a control of the device for generating a pressure difference, the control device may, for example, be configured to intentionally switch over a device for generating a pressure difference, which is configured both to generate a compressed air flow and to generate a vacuum, or to control respective separate devices. In this regard, in embodiments of the stacking apparatus comprising a product support that has a first pneumatic channel for connecting a compressed air device and a second pneumatic channel for connecting a vacuum device, the control device may be configured to control the compressed air device to generate a compressed air flow in the first pneumatic channel in order to form an air cushion along the support surface and to then control the vacuum device to suck in air through the second pneumatic channel. The device for generating a pressure difference or the compressed air device and the vacuum device may in particular further be part of the stacking apparatus and/or be connected to the stacking apparatus.

In some embodiments, the stacking apparatus may comprise a measurement device for detecting the part portion conveyed onto the product support, wherein the control device may be configured to control the device for generating an air flow in dependence on a signal of the measurement device.

For example, such a measurement device may be arranged at the front, at the center, or at the rear at the stacking apparatus with respect to the conveying direction and/or may comprise one or more light barriers arranged above the product support. This may make it possible to determine the position of a part portion conveyed onto the product support in order, for example, to start a compressed air flow for assisting the conveying of the part portion onto the product support when or just before a part portion moves onto the product support and/or to decelerate the part portion as soon as a front section of the part portion reaches the center of the support surface, goes beyond the center, or reaches a provided end position.

Furthermore, in some embodiments, the product support may be releasably fastenable to the stacking apparatus, in particular releasably fastenable without tools. For example, the product support may be pluggable onto one or more shafts, by whose rotation the product support may be movable between the feed position and the depositing position, to be able to be removed without tools and quickly, for instance, for a cleaning and to be able to be connected to the shaft again after the cleaning.

Furthermore, in some embodiments, the support surface may further have a grooved structure, a bulged structure, a corrugated structure, or a crossed structure. Due to such a structure of the support surface, the conveying effect may also be assisted and/or a friction reduction may be achieved when placing a part portion. For example, unwanted deflections of the part portion during the placement may be reduced by a grooved structure of the support surface extending perpendicular to the conveying direction.

Furthermore, the support surface may have holes passing through the product support. Due to such holes, the friction between a part portion and the support surface may also be reduced during the conveying of the part portion onto the product support and/or during the placement of the part portion.

In some embodiments, the stacking apparatus may comprise at least a first product support and a second product support that are aligned in parallel with one another in the feed position and together form the support surface. Furthermore, the first product support and the second product support may be connected to a respective shaft at mutually opposite outer sides, wherein the first product support and the second product support may be pivotable from the feed position into the depositing position by an opposite rotation of the shafts. During the placement, the part portions may thereby in particular slide along the product supports at respective mutually opposite outer sides or sides facing the shafts to be intentionally placed, and first with a central section, between two opening flaps.

In some embodiments, a common motor may be provided for driving the shafts. For this purpose, the shafts may in particular be connected via a belt or a strap to a motor shaft of the common motor to be able to achieve an opposite rotation of the shafts by a corresponding deflection.

In such embodiments with two product supports, a toothed belt or a belt for jointly driving the associated shafts and a transmission of the drive via the friction clutch already mentioned to one of the shafts may in particular be provided. On a triggering of the friction clutch, a synchronous stopping of the shafts and a constant synchronization of the shafts may thereby be ensured.

Furthermore, in some embodiments, a plurality of product supports may be arranged at a constant spacing from one another at each of the shafts. Two or four product supports may in particular be arranged at each of the shafts. The constant spacing may in particular relate to an angular position in which the product supports are arranged. This may, for example, make it possible, by moving a first product support from the feed position into the depositing position, to move the subsequent product support into the feed position so that a subsequent part portion may be directly conveyed onto the subsequent product support.

In some embodiments, provision may be made that the device for generating a pressure difference comprises at least one device for generating compressed air disposed remotely from the product support and at least one vacuum generator that is disposed in the region of or directly at the product support, preferably fastened to the product support, that is connected to the device for generating compressed air and to the pneumatic channel formed in the product support, and that is configured to generate a negative pressure by means of the supplied compressed air, in particular wherein the vacuum generator comprises at least one Venturi nozzle.

Such vacuum generators are known per se and are available on the market as ready-to-use units and are also designated as ejectors or vacuum ejectors that may e.g. have one or more Venturi nozzles in order, while using the compressed air supplied via one connection, to generate a negative pressure at another connection. Such vacuum generators may be relatively compact and only have to be connected to a compressed air source and have to be connected with their vacuum connection to the respective device to be acted on by negative pressure—here to the product support, i.e. to the pneumatic channel formed therein. The former may e.g. simply take place via a conventional compressed air hose. The latter may e.g. take place in that the vacuum generator is connected indirectly via its vacuum connection—e.g. via a hose—or directly—possibly with an interposition of a seal, for example, in the form of an O-ring—to a connection that is formed in the product support, e.g. at its support surface or at one of the other outer sides of the product support, said connection leading to the pneumatic channel or forming the start of the pneumatic channel.

Such vacuum generators may be used in a decentralized manner and make a central vacuum source superfluous that is disposed remotely from the product support and that would have to overcome comparatively long suction paths and in particular relatively high line resistances in so doing. In practice, compressed air is often available at the respective machine anyway, is required in some embodiments of the invention anyway, and may thus also be used for the vacuum generation. Double lines for positive pressure, on the one hand, and negative pressure, on the other hand, and/or the necessity of switching between “blowing”, on the one hand, and “sucking”, on the other hand, are avoided. Since the vacuum generators may be of a relatively compact design, they may be assembled “on site”, i.e. directly at or at least in the vicinity of the product support, and indeed in a manner and number adapted to the respective structural conditions and to the respective requirements for the vacuum generation.

A respective product support may be associated with exactly one vacuum generator or a plurality of vacuum generators.

If the product support is attached to a rotatable shaft, it may be connected at the entry side to the device for generating compressed air and at the output side—e.g. via a compressed air line—to the vacuum generator. The length of compressed air lines to be laid freely may hereby be reduced to a minimum while utilizing the on-site installability of the vacuum generator(s).

In accordance with some embodiments, provision may be made that, in the case of a vacuum generation, a venting possibility is provided at at least one generally arbitrary position between the vacuum source or the vacuum orifice, e.g. at the pneumatic channel having the vacuum orifice, e.g. in the form of a venting opening that may be permanent or closable and that may in particular—like an aperture or like a settable throttle—be settable with respect to its size. After the placement of a respective part portion, an automatic venting may hereby take place that ensures that the same initial conditions are provided again for a respective next portion within a short time, i.e. that there is no residual vacuum, which would lead to an undefined and in this regard an unwanted deceleration of the next portion.

This would in particular be disadvantageous if a plurality of part portions are to be placed at the same time or if a plurality of pneumatic channels or vacuum orifices are effective for one part portion, which could unintentionally lead to different braking effects at different levels of a respective residual vacuum which would in turn bring about different alignments of a plurality of part portions with one another or an unwanted rotation of a part portion. Ensuring a rapid venting eliminates these potential disadvantages.

Furthermore, in some embodiments, provision may be made that, viewed in the conveying direction, a braking support for the part portions to be conveyed onto the product support is arranged in the entry region of the product support. A pre-braking of the part portions may hereby be achieved. The braking support may be removable. A set of different, mutually interchangeable braking supports may be provided to be able to provide different pre-braking effects in an application-specific manner. The braking support may e.g. be a strip composed of metal or plastic that may be attached to the product support and whose support side serving as a braking surface has been provided with properties that produce a desired braking effect in each case, e.g. by applying a material, for example in the form of a coating or a support, or by an e.g. mechanical processing such as a roughening.

The invention further relates to a product support for a stacking apparatus for preparing a food portion, in particular for a stacking apparatus of the kind disclosed herein, comprising at least one pneumatic channel that is formed in the product support, that may be connected to a device for generating a pressure difference, and that has at least one orifice into a support surface of the product support.

This product support, the at least one pneumatic channel, and/or the at least one orifice may in particular have the features explained above in connection with the stacking apparatus. Such a product support may generally also be used in conventional stacking apparatuses and may replace the product supports of such stacking apparatuses, wherein only a connection of the product support or its pneumatic channel to a device for generating a pressure difference is required to enable the above-explained precise conveying of part portions onto the product support and/or their precise placement. A new design of the stacking apparatus is therefore not absolutely necessary, but the product support may also be used to retrofit existing stacking apparatuses.

In some embodiments, the product support may be produced by a 3D printing process. Such a process in particular makes it possible to form the at least one pneumatic channel and in particular a plurality of pneumatic channels, for example a first pneumatic channel for connection to a compressed air device and a second pneumatic channel for connection to a vacuum device, in a simple manner in the interior of the product support.

The invention furthermore relates to a method of preparing a food portion by means of a stacking apparatus, in particular by means of a stacking apparatus of the kind disclosed herein. In this method, a part portion is transported along a conveying direction to the stacking apparatus and is conveyed onto a product support of the stacking apparatus, wherein, on the conveying of the part portion through a pneumatic channel formed in the product support, an air flow directed along a support surface of the product support is generated and/or air is sucked in through the pneumatic channel. Furthermore, the part portion conveyed onto the product support is placed beneath the product support by moving the product support away.

In this method, a stack of part portions may in particular be formed beneath the product support by a successive placement of part portions so that the food portion prepared when carrying out the method may be formed by such a stack of part portions. As already explained, by generating such air flows, a precise conveying of the part portion onto the product support and/or a precise placement of the part portion beneath the product support may be achieved in order, for example, to be able to stack the respective part portions exactly on top of one another and to prepare the food portion. In this respect, a precise conveying may also mean that the part portions are not only conveyed further in a straight line along the conveying direction, but are deliberately influenced in order, for example, to change the position laterally or to rotate the part portion.

In some embodiments, for conveying the part portion, a compressed air flow may first be generated along the support surface and air may then be sucked in at the support surface. A part portion that is, for example, guided to the stacking apparatus by means of a conveyor belt may thus first be moved further along the support surface assisted by a compressed air flow in order thereupon, when reaching a desired position, to be able to be braked and exactly positioned on the support surface by sucking in air.

In some embodiments, provision may be made that a strength of the compressed air flow and/or of the suction during the conveying of the part portion is constant or is varied in time and/or in space. In particular by varying the air flow, the conveying and/or placement of a part portion may be precisely controlled and regulated in time and/or in space.

In some embodiments, the strength of the compressed air flow and/or of the suction may be set and/or varied in time and/or in space in dependence on a property of the part portion, in particular a weight of the part portion. Due to such a setting or variation, an adaptation to certain products may in particular be achieved in that, for example, the strength of the compressed air flow may be increased to be able to convey a relatively heavy part portion along the product support. Corresponding settings may, for example, be predefinable by a user or the stacking apparatus may have a memory in which corresponding settings are stored in dependence on certain properties of the part portions to be processed. The properties of the part portion, in particular a weight, may, for example, be transmitted from a scale connected upstream of the stacking apparatus to a control device of the stacking apparatus so that the latter may automatically read out the corresponding setting from the memory and may control the device for generating a pressure difference accordingly. The transmission of a weight to be expected by the slicer or its control is also conceivable. Furthermore, settings of the stacking apparatus may in particular be adapted in dependence on parameters of a preceding cutting process to be able to adapt the settings of the stacking apparatus to changing parameters and correspondingly changed part portions. For this purpose, such parameters, for example a slice thickness or a number of slices of a part portion, may be transmitted from a control of a high-performance slicer to the stacking apparatus and/or its control.

Furthermore, in some embodiments, provision may be made that the suction is omitted when a defective part portion, in particular an underweight part portion, is transported to the stacking apparatus. Alternatively or additionally, provision may also be made that an expulsion means is positioned beneath the product support before the placing of the defective portion.

Since the suction may be omitted for a defective part portion, such a defective part portion may, for example, be conveyed beyond the product support and may be fed to an expulsion section, in particular a conveyor belt, to be able to be manually checked and/or completed. Thus, only complete and desired part portions may be placed so that, for example, a food portion assembled from a plurality of part portions by means of the stacking apparatus has the desired properties and does not have to be manually checked or completed. Alternatively thereto, such an expulsion of defective part portions may also be achieved in that an expulsion means is positioned beneath the product support so that the part portion may be placed on the expulsion means. For this purpose, the expulsion means may, for example, be pivoted below the product support when a defective part portion is recognized. By moving the expulsion means away, such a defective part portion may also be fed to an expulsion section in order to be manually checked and/or completed. Due to such an expulsion of defective part portions at the stacking apparatus, an expulsion in preceding processing steps, for example through a rocker arranged downstream of a slicing apparatus, may in particular be omitted so that the length of a processing line, which may comprise a slicing apparatus, the stacking apparatus and a packaging machine, may be reduced overall.

The invention will be explained in the following purely by way of example with reference to an embodiment and to the drawings.

THERE ARE SHOWN:

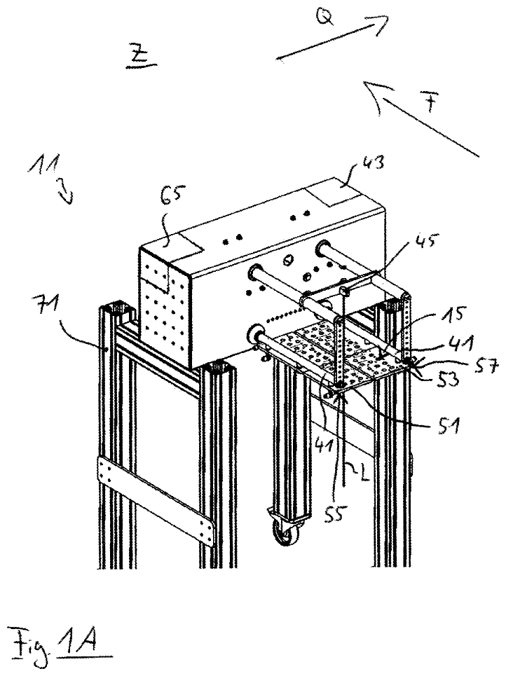

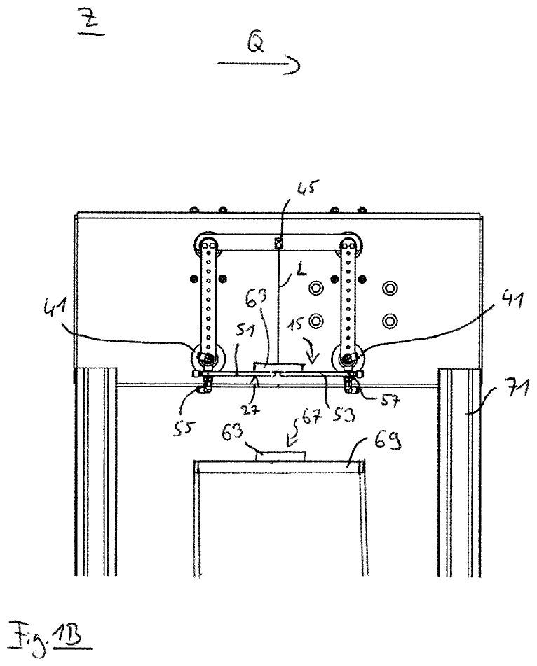

FIGS. 1A and 1B a perspective front view and a front view of a stacking apparatus for preparing food portions with a first and a second product support in a feed position in which a part portion may be conveyed onto a support surface formed by the first product support and the second product support;

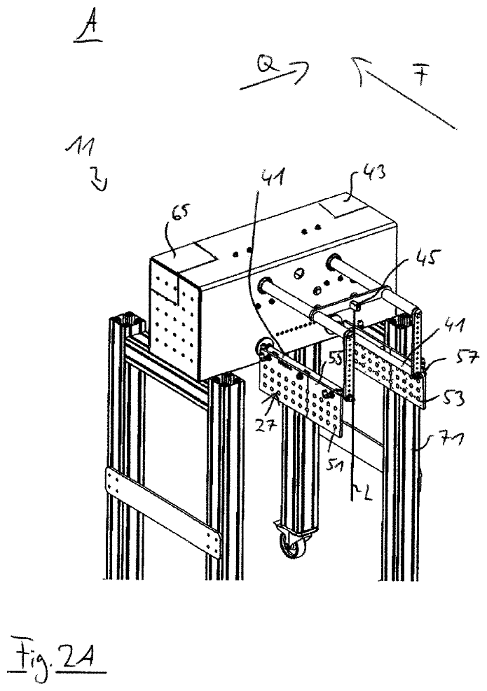

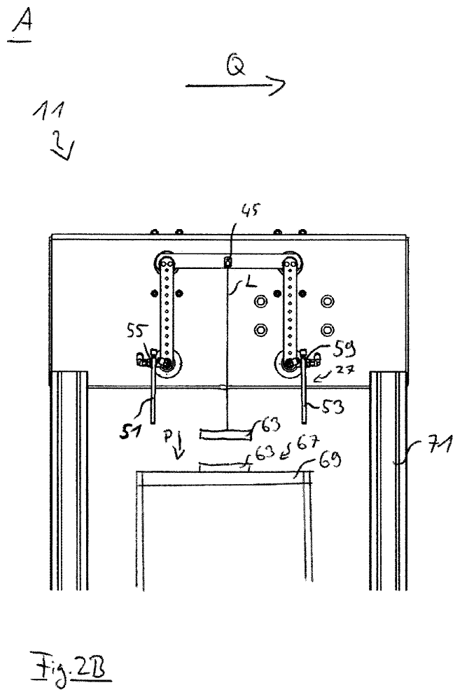

FIGS. 2A and 2B a perspective front view and a front view of the stacking apparatus, wherein the product supports are moved into a depositing position in which a part portion conveyed onto the product supports may be placed beneath the product support;

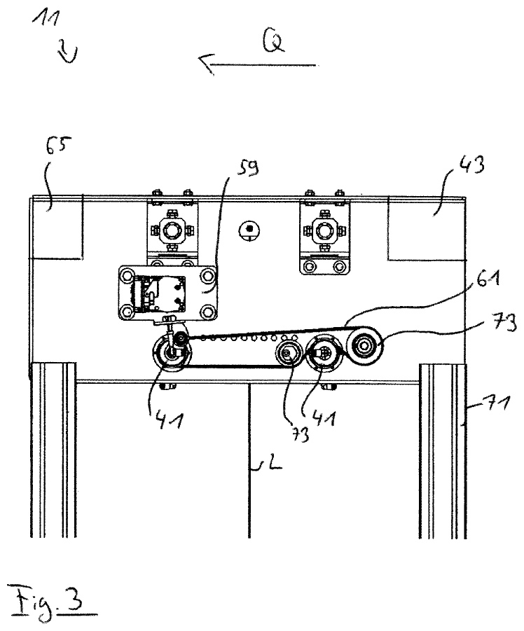

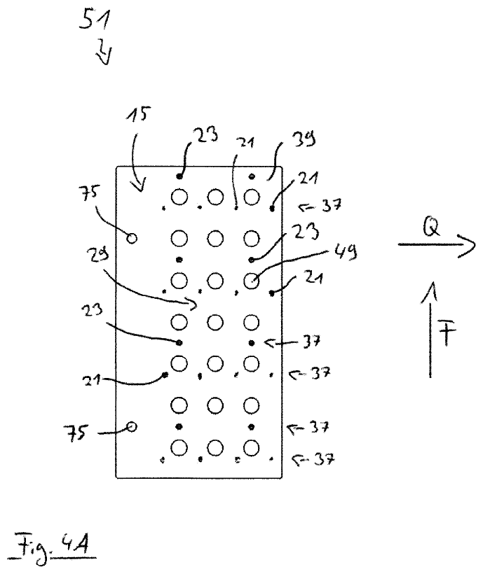

FIG. 3 a rear view of the stacking apparatus;

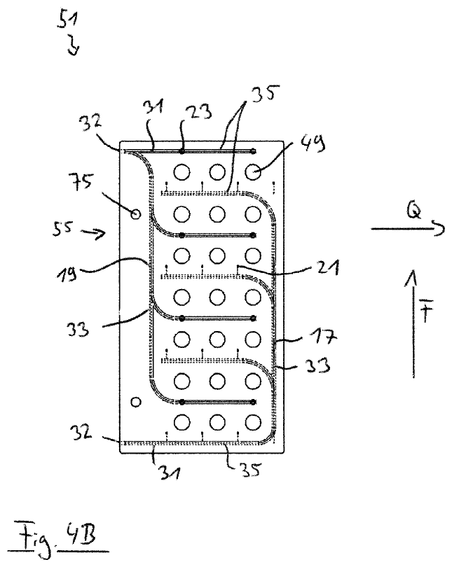

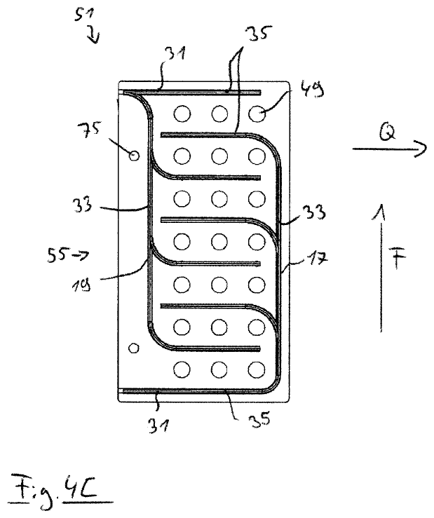

FIGS. 4A to 4D a plan view of the first product support, a plan view of the first product support with a transparent upper side, a cross-sectional representation of the first product support, and a bottom view of the first product support;

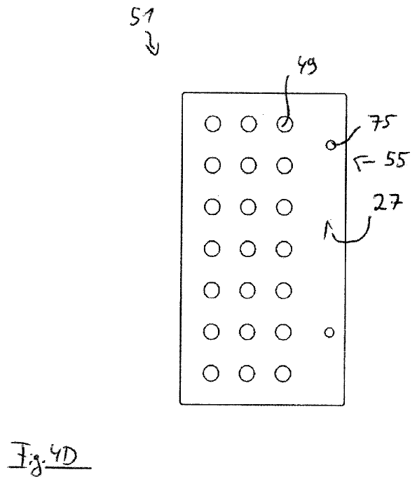

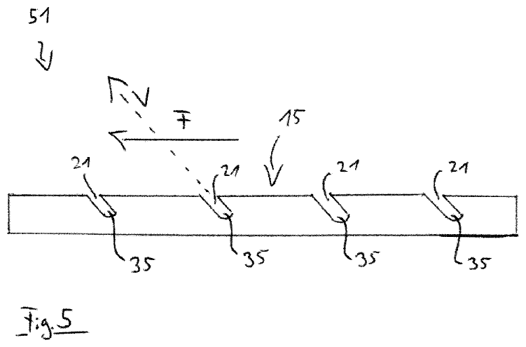

FIG. 5 a longitudinal sectional representation of the first product support; and

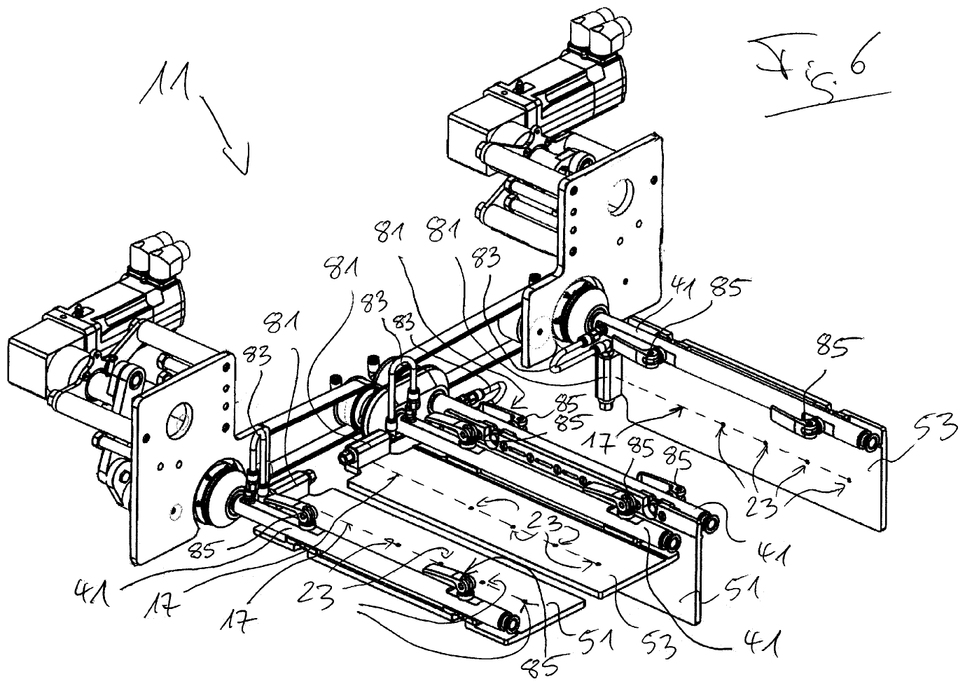

FIG. 6 a view corresponding to FIG. 1A (detail) of a further embodiment.

FIGS. 1A to 2B show a stacking apparatus 11 for preparing a food portion 67 that comprises a first product support 51 and a second product support 53 that are movable between a feed position Z shown in FIGS. 1A and 1B and a depositing position A shown in FIGS. 2A and 2B. In the feed position Z, the product supports 51 and 53 are aligned in parallel with a conveying direction F so that when the product supports 51 and 53 are in the feed position Z, a part portion 63 may be conveyed along the conveying direction F onto a support surface 15 formed by the product supports 51 and 53 (cf. in particular FIG. 1B). This may, for example, take place by means of a conveyor belt, not shown, connected upstream of the stacking apparatus 11 against the conveying direction F. By moving the product supports 51 and 53 into the depositing position A, the part portion 63 conveyed onto the product supports 51 and 53 may, in contrast, as FIG. 2B shows, be placed beneath the product supports 51 and 53, wherein the part portion 63 falls down along an arrow P after the movement of the product supports 51 and 53.

The stacking apparatus 11 further has a frame 71 by means of which the product supports 51 and 53 are held and are positioned above a transport belt 69. The part portions 63 may thereby be placed on the transport belt 69 and may be stacked thereon to prepare a complete food portion 67. The complete food portion 67, in particular a stack of a plurality of part portions 63, may then be fed by means of the transport belt 69 to further processing steps and, for example, to a packaging machine.

To enable the movement of the product supports 51 and 53 between the feed position Z and the depositing position A, the product supports 51 and 53 are connected at their outer sides 55 and 57 to a respective shaft 41 so that the product supports 51 and 53 may be transferred from the feed position Z into the depositing position A by an opposite rotation of the shafts 41 about 90 degrees (cf. FIGS. 1A to 2B). To transfer the product supports 51 and 53 into the feed position Z again, the direction of rotation of the shafts 41 may, for example, be changeable and the product supports 51 and 53 may again be moved into the feed position Z by a rotation the shafts 41 about 90 degrees. However, provision may also be made that the direction of rotation of the shafts 41 is not changeable and/or is changed so that the product supports 51 and 53 may be transferred from the depositing position A back into the feed position Z by a further rotation of the shafts 41 about 270 degrees to pick up a subsequent part portion 63. Furthermore, a plurality of product supports and, for example, four product supports offset from one another by 90 degrees in each case may generally also be fastened to the shafts 41 so that, by moving a product support from the feed position Z into the depositing position A, a product support following against the direction of rotation may automatically move into the feed position Z.

To drive the shafts 41, a common motor 59 is, as FIG. 3 shows, provided at a rear side of the stacking apparatus 11 and is connected to the shafts 41 via a strap 61. The strap 61 runs over two deflection rollers 73 and is thereby guided around the shafts 41 such that they may be set into a rotation in opposite directions to one another by means of the common motor 59.

The motor 59 may in particular further be connected to the shaft 41 via a friction clutch, not shown, to limit the torque that may be transmitted to the shaft 41. It may thereby be achieved that the shafts 41 are stopped when a user reaches into the stacking apparatus 11 during the operation and blocks the product support 51 or 53 so that an injury to the user is prevented. By connecting the shafts 41 via the strap 61, the transmission of torque to the shafts 41 may also be synchronously interrupted when one of the product supports 51 and 53 is blocked so that the shafts 41 or the product supports 51 and 53 may be moved further in a mutually synchronous rotational position after the interruption has ended.

Such a stacking apparatus 11 may in particular be provided as part of a processing line to assemble a food portion 67 from a plurality of previously prepared part portions 63, said food portion 67 then, for example, being able to be transferred to a packaging machine for a joint packaging of the food portion. For example, such an approach may be provided for part portions 63 that were prepared by a slicing machine for food products and that comprise a plurality of slices of a meat or cheese product, wherein food portions 67 comprising a plurality of such part portions 63 may be jointly packaged, for instance, as an offer for bulk buyers from the catering industry. To be able to separate the individual part portions 63 from one another again and to be able to remove them from the package, a so-called underleaver—a piece of paper or a film—may also be arranged below each part portion 63 for such products by means of a slicing machine.

A problem with such stacking apparatuses 11 is often that the part portions 63 have to be positioned as exactly as possible on the support surface 15 and have to be placed as precisely as possible to be able to prepare a desired food portion 67. In conventional stacking apparatuses 11, the part portions 63 are, however, usually transferred to the stacking apparatus 11 only by means of a conveyor belt connected upstream, which is not shown in the Figures, and are so-to-say pushed onto the product supports 51 and 53, wherein unwanted deflections of the part portion 63 and incorrect positionings may occur due to the friction between the product supports 51 and 53 so that the part portions 63 may not be stacked exactly on top of one another, for example.

To counter this problem, a respective first pneumatic channel 17 and a respective second pneumatic channel 19 are formed in the product supports 51 and 53 of the stacking apparatus 11 shown here, wherein the pneumatic channels 17 and 19 may be connected to a device 65 for generating a pressure difference (cf. in particular FIGS. 4B, 4C, and 5). The respective first pneumatic channel 17 has a plurality of compressed air orifices 21 into the support surface 15 and the respective second pneumatic channel 19 has a plurality of vacuum orifices 23 into the support surface 15 (cf. FIGS. 4A, 4B, 4C, and 5). In the following, the configuration of the product supports 51 and 53 will be explained in more detail by way of example with reference to FIGS. 4A to 5 for the first product support 51.

As FIG. 4A shows, the compressed air orifices 21 leading into the support surface 15 are arranged in a plurality of rows 37 offset in parallel from one another along the conveying direction F, wherein the rows 37 extend along a transverse direction Q oriented perpendicular to the conveying direction F. In each of the rows 37, four compressed air orifices 21 are arranged by way of example so that four compressed air orifices 21 offset from one another along the transverse direction Q lead into the support surface 15 in each of the rows 37.

Furthermore, the plurality of vacuum orifices 23 into the support surface 15 are also arranged in a plurality of rows 37 aligned in parallel with one another and extending along the transverse direction Q, wherein each of the rows 37 of vacuum orifices 23 have two vacuum orifices 23. In this regard, the product surface 51 shown here comprises twice as many compressed air orifices 21 as vacuum orifices 23. The compressed air orifices 21 and the vacuum orifices 23 are circular, wherein the vacuum orifices 23 have a larger cross-sectional surface than the compressed air orifices 21. Alternatively thereto, the compressed air orifices 21 and/or the vacuum orifices 23 may, however, also have a different cross-sectional shape, for example, elliptical, rectangular, or square. Furthermore, the compressed air orifices 21 and the vacuum orifices 23 may generally also have an identical cross-sectional surface and/or a different cross-sectional shape from one another.

FIGS. 4B and 4C show the first pneumatic channel 17 formed in the interior of the product support 51 and the second pneumatic channel 19 formed in the interior of the product support 51. Both the first pneumatic channel 17 and the second pneumatic channel 19 have a respective connection 32 to be able to be connected to the device 65 for generating a pressure difference. The connections 32 are arranged at an outer side 55 of the product support 51 facing the shaft 41 so that the pneumatic channels 17 and 19 may be connected to the device 65 for generating a pressure difference by respective pneumatic lines—not shown in the Figures—extending within the shafts 41.

Furthermore, the connections 32 form one end of a respective connection section 31 of the pneumatic channel 17 or 19 that extends along the transverse direction Q and that is connected to a supply section 33 aligned in parallel with the conveying direction F. Respective work sections 35, which are aligned in parallel with one another and which are oriented perpendicular to the conveying direction F, branch off from the supply sections 33. Each of the work sections 35 leads to a respective row 37 of compressed air orifices 21 or vacuum orifices 23 so that the compressed air orifices 21 and the vacuum orifices 23 may be connected to the device 65 for generating a pressure difference via the respective pneumatic channel 17 or 19. Furthermore, the connection section 31 of the first pneumatic channel 17 is likewise connected to a row 37 of compressed air orifices 21 and the connection section 31 of the second pneumatic channel 19 is connected to a row 37 of vacuum orifices 23 so that, in the embodiment shown, the connection sections 31 also function as work sections 35.

As can further be seen from FIG. 4B, the vacuum orifices 23 are in alignment with the respective associated work section 35 of the second pneumatic channel 19 perpendicular to the support surface 15 so that the vacuum orifices 23 are also oriented perpendicular to the support surface 15. In contrast, outlets of the compressed air orifices 21 are arranged offset from the respective associated work sections 35 along the conveying direction F so that the compressed air orifices 21 are oriented inclined to the conveying direction F. With such an orientation of the compressed air orifices 21, a straight-line extension V of the compressed air orifices 21 intersects the conveying direction F at an acute angle, as FIG. 5 shows, so that an air flow exiting from the compressed air orifices 21 has a component in the direction of the conveying direction F. As will be explained in more detail below, the conveying of the part portion 63 onto the product support 51 may in particular be assisted by such an air flow.

As can in particular be seen from the representation of FIG. 4D, which shows a lower side 27 of the product support 51, the pneumatic channels 17 and 19 extend completely in the interior of the product support 51—between the support surface 15 and the lower side 27—from the connection 32 to the compressed air orifices 21 and the vacuum orifices 23. To achieve such a configuration of the product support 51 with pneumatic channels 17 and 19 extending in the interior, the product support 51 may in particular be produced by a 3D printing process. By means of such a 3D printing process, a generally arbitrary number of pneumatic channels may be formed in the interior of a product support 51 in a simple manner, wherein their course may also be changed as desired by a corresponding adaption of the model on which the process is based. For example, provision may be made to guide the respective supply sections 33 at the center of the product support 51, wherein the work sections 35 may, for example, branch off from the supply sections 33 at both sides in such a configuration. Furthermore, product supports may be formed with more than two pneumatic channels extending in the interior.

Furthermore, the product supports 51 and 53 are formed with continuous holes 49, whereby the friction between the product supports 51 and 53 and the part portions 63 may be reduced during the placement. Respective openings 75 are furthermore formed at the outer sides 55 and 57 of the product supports 51 and 53, through which openings 75 the product supports 51 and 53 may be connected to the respective shaft 41 and may in particular be plugged onto the shafts 41 (cf. FIGS. 4A to 4D). This may enable a tool-free connection of the product supports 51 and 53 to the shafts 4 and a tool-free removal of the product supports 51 and 53 in order, for example, to be able to remove them quickly and in an uncomplicated manner for a cleaning process and to be able to mount them at the shafts 41 again after the cleaning.

The pneumatic channels 17 and 19, which extend in the interior of the product supports 51 and 53 and which open with a plurality of compressed air orifices 21 or vacuum orifices 23 into the support surface 15, in particular make it possible to precisely convey the part portions 63 onto the support surface 15 and/or to stop them in a desired position on the support surface 15. Furthermore, the placement of the part portions 63 may be assisted by a corresponding control of the device 65 for generating a pressure difference.

For example, provision may be made, during a conveying of a part portion 63 onto the product supports 51 and 53, to first generate a compressed air flow in the first pneumatic channel 17 by means of the device 65 for generating a pressure difference so that compressed air exits from the compressed air orifices 21 of the support surface 15 and forms an air cushion for the part portion 63 conveyed onto the product supports 51 and 53 in order to assist the conveying of the part portion 63. To achieve as precise as possible a positioning of a part portion 63 on the support surface 15, a braking effect may further be developed by generating a vacuum in the second pneumatic channel 19 and by sucking in air through the vacuum orifices 23 in order to decelerate and to position a part portion 63 conveyed onto the support surface 15. During a placement of a part portion 63, a friction between the part portion 63 and the product supports 51 and 53 may, for example, also be reduced by generating a compressed air flow in the first pneumatic channel 17 in order, for instance, to prevent a slipping of the part portion 63 during the placement.

During the conveying of the part portions 63 onto the product supports 51 and 53, the first pneumatic channel 17 may thus in particular first have compressed air applied to it, whereupon air may be sucked in through the second pneumatic channel 19 and the part portion 63 may be decelerated. To enable such a control, the stacking apparatus 11 has a control device 43 that is configured to control the device 65 for generating a pressure difference. The control device 43 may also be configured to temporally vary the air flow generated in the first pneumatic channel 17 and/or the second pneumatic channel 19 and in particular the strength of the air flow. Furthermore, the control device 43 may be configured to adapt a strength of the respective air flow in dependence on a property of the part portion 63, in particular its weight.

Furthermore, the stacking apparatus 11 has a measurement device 45 that is configured here as a light barrier and that emits a light beam L. The measurement device 45 is arranged above the support surface 15 and at its center so that it may be detected by means of the measurement device 45 when a part portion 63 has been conveyed up to the center of the support surface 15. The control device 43 may, for example, be configured, as a result of a signal of the measurement device 45 that indicates the reaching of the center of the support surface 15 by a part portion 63, to suck in air from the support surface 15 through the second pneumatic channel 19, instead of a compressed air flow in the first pneumatic channel 17, so that a deceleration and a positioning of the part portion 63 may take place instead of the conveying effect to be achieved by applying compressed air to the first pneumatic channel 17. Furthermore, the stacking apparatus 11 may generally also have a plurality of measurement devices 45 to be able to exactly determine the position of a part portion 63 on the support surface 15 and to be able to precisely control the device 65 for generating a pressure difference in dependence on this position.

Provision may furthermore be made that the control device 43 is configured to control the device 65 for generating a pressure difference to apply compressed air to the first pneumatic channel 17, but to suspend the subsequent sucking in of air through the second pneumatic channel 19 when a defective and, for example, underweight portion 63 is conveyed to the stacking apparatus 11. For this purpose, the product supports 51 and 53 and/or the shafts 41 may in particular be arranged offset downwardly at the stacking apparatus 11 with respect to the position shown in FIGS. 1A to 3 so that such a defective part portion 63 may be moved beyond the support surface 15 in the conveying direction F and may, for example, be fed to a conveyor belt, not shown in the Figures, that is arranged behind said support surface 15 and that guides the part portion 63 to an expulsion section. There, the part portion 63 may, for example, be checked and/or manually completed. Alternatively thereto, an expulsion means may also be movable and, for example, pivotable in below the product supports 51 and 53 to be able to collect a defective part portion 63 and to feed it to an expulsion section.

In the embodiment illustrated by means of the Figures, the device 65 for generating a pressure difference is shown by way of example as part of the stacking apparatus 11. However, provision may also be made that the stacking apparatus 11 and/or the product supports 51 and 53 is/are selectively connectable to such a device 65 for generating a pressure difference. Furthermore, provision may be made that the device 65 for generating a pressure difference is configured both to apply a compressed air flow to the first pneumatic channel 17 and to suck in air through the second pneumatic channel 19 through the vacuum orifices 23.

Alternatively thereto, a separate compressed air device and a separate vacuum device may, however, also be provided to be able to generate the corresponding air flows at the support surface 15.

Furthermore, in the embodiment shown, the compressed air orifices 21 and the vacuum orifices 23 are arranged uniformly distributed at the support surface 15. However, provision may also be made that, for example, more compressed air orifices 21 are arranged in a respective marginal section facing the outer side 55 or 57 of the product supports 51 or 53, wherein the compressed air orifices 21 may in particular also be oriented in the direction of the respective opposite inner side of the product supports 51 and 53 in this case. Such an orientation and arrangement of the compressed air orifices 21 may in particular make it possible to center the part portions 63 on the support surface 15. Furthermore, provision may be made to arrange a higher density of compressed air orifices 21 in a region at which the part portions 63 are taken over by a device connected upstream or a conveyor belt to intentionally assist the conveying of the part portions 63 along the product supports 51 and 53 in this region.

The embodiment of FIG. 6 shows, among other things, that the stacking apparatus 11 may also be formed with two tracks, wherein, in the state shown here, the product supports 51, 53 of the left track are in the feed position and the product supports 51, 53 of the right track are in the depositing position.

In this embodiment, in each case only a deceleration of the part portions takes place by applying a negative pressure to a plurality of vacuum orifices 23, here in each case four arranged in a central row, via a pneumatic channel 17, indicated by dashed lines here, that is connected to a respective vacuum generator 81 that is in turn connected via a compressed air hose 83 to the respective shaft 41 that is connected to a compressed air source (e.g. the device 65 in accordance with the previously described embodiment; not shown here).

The vacuum generator 81 may e.g. be a vacuum ejector such as has been described elsewhere in this disclosure and that has one or more Venturi nozzles by means of which a negative pressure is generated in the pneumatic channel 17 from the supplied compressed air and air is thus sucked in through the vacuum orifices 23.

The vacuum generators 81 are each of such a compact design that they may be attached to the respective product support 51, 53 and may be directly connected with their downwardly facing vacuum connection to a suction opening leading to the pneumatic channel 17 or forming the start of the pneumatic channel 17.

Such a decentralized on-site vacuum generation directly at the respective product support 51, 53 requires little installation space and makes long vacuum lines and powerful central vacuum sources, e.g. in the form of expensive vacuum pumps, superfluous, wherein energy is also saved since power losses due to long suction paths are avoided. Furthermore, an adaptation to the respective structural conditions may take place in a simple manner since the vacuum generators 81 may also be attached to a different position of a respective product support 51, 53 if the suction opening associated with the respective pneumatic channel 17 is positioned accordingly. However, the connection of a vacuum generator 81 to the suction opening of the pneumatic channel 17 does not have to take place directly, but may alternatively take place via a vacuum line such as a flexible hose.

A vacuum generator 81 does not have to be directly attached to a respective product support 51, 53, but may also be positioned at another position of the stacking apparatus 11, preferably in the vicinity of the respective product support 51, 53, so that only a relatively short vacuum line is required. For this purpose, the decentralized vacuum generation by means of the individual vacuum generators 81 provides a high degree of flexibility.

To be able to mount the product supports 51, 53 at the respective shaft 41 without tools, two quick release fasteners 85 are provided in each case.

### REFERENCE NUMERAL LIST

11 stacking apparatus
15 support surface
17 first pneumatic channel
19 second pneumatic channel
21 compressed air orifice
23 vacuum orifice
27 lower side
31 connection section
32 connection
33 supply section
35 work section
37 row
41 shaft
43 control device
45 measurement device
49 hole
51 first product support
53 second product support
55 outer side
57 outer side
59 motor
61 strap
63 part portion
65 device for generating a pressure difference
67 food portion
69 transport belt
71 frame
73 deflection roller
75 opening
81 vacuum generator
83 compressed air hose
85 quick release fastener
A depositing position
F conveying direction
L light beam
P arrow
Q transverse direction
V extension
Z feed position

1-33. (canceled)

34. A stacking apparatus for preparing food portions,
said stacking apparatus comprising at least one product support movable between a feed position and a depositing position,
wherein, in the feed position of the product support, a part portion of the food portion to be prepared can be conveyed along a conveying direction onto a support surface of the product support, and wherein the stacking apparatus is configured to place the part portion conveyed onto the product support beneath the product support by moving the product support into the depositing position, and
wherein, in the product support, at least one pneumatic channel is formed that can be connected to a device for generating a pressure difference and that has at least one orifice into the support surface.

35. A stacking apparatus in accordance with claim 34,
wherein the pneumatic channel has a connection for the device for generating a pressure difference to the product support and, starting from the connection, extends in the interior of the product support, between the support surface and a lower side of the product support opposite the support surface, to the at least one orifice.

36. A stacking apparatus in accordance with claim 34,
wherein the orifice of the pneumatic channel is at least one of oriented inclined to the support surface or oriented in the direction of a central section of the support surface.

37. A stacking apparatus in accordance with claim 34,
wherein the orifice is formed as at least one of a shallow depression, a shallow funnel, or a trough.

38. A stacking apparatus in accordance with claim 34,
wherein the orifice merges into a shallow groove formed at the support surface.

39. A stacking apparatus in accordance with claim 34,
wherein the pneumatic channel has a plurality of orifices into the support surface.

40. A stacking apparatus in accordance with claim 39,
wherein the pneumatic channel has a connection section for connecting the pneumatic channel to the device for generating a pressure difference, a supply section, and a plurality of work sections branching off from the supply section,
wherein the supply section forms the connection section or merges into the connection section, and
wherein each of the work sections leads to at least one respective orifice into the support surface.

41. A stacking apparatus in accordance with claim 39,
wherein the orifices are arranged closer to one another in a marginal section of the support surface than in a central section of the support surface.

42. A stacking apparatus in accordance with claim 34,
wherein the product support is connected at an outer side to a rotatable shaft, wherein the product support can be pivoted from the feed position into the depositing position by rotating the shaft,
wherein at least one pneumatic line is formed in the rotatable shaft, via which pneumatic line the at least one pneumatic channel can be connected to the device for generating a pressure difference.

43. A stacking apparatus in accordance with claim 34,
wherein, in the product support, at least a first pneumatic channel is formed that can be connected to a compressed air device for generating compressed air and that has at least one compressed air orifice into the support surface,
and wherein, in the product support, at least a second pneumatic channel is formed that can be connected to a vacuum device for generating a vacuum and that has at least one vacuum orifice into the support surface.

44. A stacking apparatus in accordance with claim 43,
wherein the at least one compressed air orifice is oriented inclined to the support surface and wherein the at least one vacuum orifice is oriented perpendicular to the support surface.

45. A stacking apparatus in accordance with claim 34,
wherein the stacking apparatus comprises a control device for controlling the device for generating a pressure difference.

46. A stacking apparatus in accordance with claim 45,
wherein the control device is configured to control the device for generating a pressure difference during the conveying of the part portion onto the product support to first apply compressed air to the at least one pneumatic channel and to then suck in air through the at least one pneumatic channel.

47. A stacking apparatus in accordance with claim 45,
wherein the stacking apparatus comprises a measurement device for detecting the part portion conveyed on the product support, wherein the control device is configured to control the device for generating an air flow in dependence on a signal of the measurement device.

48. A stacking apparatus in accordance with claim 34,
wherein the stacking apparatus comprises at least a first product support and a second product support that are aligned in parallel with one another in the feed position and together form the support surface,
wherein the first product support and the second product support are connected to a respective shaft at mutually opposite outer sides, and wherein the first product support and the second product support can be pivoted from the feed position into the depositing position by an opposite rotation of the shafts.

49. A stacking apparatus in accordance with claim 34,
wherein the device for generating a pressure difference comprises at least one device for generating compressed air disposed remotely from the product support and at least one vacuum generator that is disposed in the region of or directly at the product support, that is connected to the device for generating compressed air and to the pneumatic channel formed in the product support, and that is configured to generate a negative pressure by means of the supplied compressed air.

50. A stacking apparatus in accordance with claim 49,
wherein the vacuum generator comprises at least one Venturi nozzle.

51. A product support for a stacking apparatus for preparing a food portion,
said product support comprising at least one pneumatic channel that is formed in the product support, that can be connected to a device for generating a pressure difference, and that has at least one orifice into a support surface of the product support.

52. A product support in accordance with claim 51,
wherein the product support is manufactured by a 3D printing process.

53. A method of preparing a food portion by means of a stacking apparatus,
in which a part portion is transported along a conveying direction to the stacking apparatus and is conveyed onto a product support of the stacking apparatus,
wherein, on the conveying of the part portion through a pneumatic channel formed in the product support, at least one of an air flow directed along a support surface of the product support is generated or air is sucked in through the pneumatic channel, and
wherein the part portion conveyed onto the product support is placed beneath the product support by moving the product support away.

54. A method in accordance with claim 53,
wherein, for conveying the part portion, a compressed air flow is first generated along the support surface and air is then sucked in at the support surface.
